(19) United States
(12) Patent Application Publication
(10) Pub. No.: US 2023/0063532 A1
(43) Pub. Date: Mar. 2, 2023

(54) DATA TRANSMISSION METHOD

(71) Applicant: Hitbox Entertainment GmbH, Wien (AT)

(72) Inventors: Martin KLIMSCHA, Wien (AT); Max KOSSATZ, Wien (AT); Markus LEITSCH, Wien (AT); René WEINBERGER, Wien (AT)

(73) Assignee: Hitbox Entertainment GmbH, Wien (AT)

(21) Appl. No.: 17/799,361

(22) PCT Filed: Feb. 13, 2020
(86) PCT No.: PCT/EP2020/053795

§ 371 Date: Aug. 12, 2022

(51) Int. Cl. H04N 21/2187; H04L 65/611; H04L 65/65; H04N 21/61; H04N 21/8547; H04N 21/6437

(52) U.S. Cl. CPC H04N 21/2187; H04L 65/611; H04L 65/65; H04N 21/6125; H04N 21/6131; H04N 21/8547; H04N 21/6437

(57) ABSTRACT

Method for data transmission, in which an audiovisual media stream of a live (e.g., sporting) event, is transmitted by a first provider via the Internet and/or via at least one mobile radio network to a plurality of user terminals, and a data stream generated on the basis of the live event is made available by a second provider. The audiovisual media stream and the data stream are fed to a data preparation device, which generates a sequence of temporally spaced data packets and provides each data packet with identification information identifying the respective data packet and a time stamp. The generated data packets are synchronized with the media stream at controllable time intervals by the time stamp and sent via a bidirectional communication link by real-time transfer protocols and real-time streaming protocols to a group of user terminals for simultaneous playback synchronized with the audiovisual media stream.

The invention relates to a method of data transmission in which an audiovisual media stream of a live event, for example a sports event, is sent by a first provider via the Internet and/or via at least one mobile telephone network to a plurality of user terminals, and a data stream generated on the basis of the live event is made available by a second provider for further processing or display via the Internet and/or via at least one mobile telephone network, according to the preamble of claim 1.

Such methods make it possible to provide live broadcasts of audiovisual data relating to events, such as sporting events, over the Internet or one or more mobile telephone networks. In this context, live transmission means that the audiovisual data on an event is not subject to any further time delays apart from the delay generated in the preparation and transmission process. In the case of the broadcasting of audiovisual data via television stations, which has been common practice for decades, audiovisual data content such as images and sound recorded at the location of the event can be transmitted to the receiving terminal, such as a consumer's television set, within a few seconds. This time delay caused by processing and broadcasting is also called latency time.

However, the consumption of audiovisual data by consumers is increasingly shifting from immobile terminals such as TV sets, which obtain the audiovisual data exclusively from TV stations, to mobile terminals such as tablets and smartphones, which access audiovisual data via Internet access. In this context, the term OTT (over-the-top content) is also used, which refers to the transmission and sale of audiovisual data content, also referred to as audiovisual media streams in the following, via Internet access, usually without involving the Internet service providers (ISPs) themselves in the control and distribution of the data content. The transmission of audiovisual media streams is done in the traditional way, for example by HTTP streaming, wherein the audiovisual data is divided into small pieces of the whole file and transmitted as data segments via conventional web servers, which are used for the delivery of the segments. Each segment comprises a certain number of bits. One part of the bits forms the actual user data and another part of the bits forms a data start block that contains specific control information. This control information is used by Internet servers to route the data segments to their destination. The transmission protocols used for this are usually TCP (Transmission Control Protocol), UDP (User Datagram Protocol) and IP (Internet Protocol). In the case of mobile devices, which are also referred to as user terminals in the following, the segments must subsequently be reassembled in such a way that continuous playback of the entire media stream is possible. However, this process causes latency times that are usually between 3 and 40 seconds, but can also be significantly higher. These comparatively long latency periods are primarily due to the transmission protocols used, such as HLS or MPEG-DASH, which have been optimized less for the rapid transmission of data and more for the successful and complete transmission of audiovisual data under Internet connections, which were still sometimes unstable in the past, to technically less powerful but also less versatile terminal equipment. In particular, the intermediate buffering of the data used and the merging of the individual data segments to form a playable media content in a user's terminal device caused the delays in the display of the data content.

However, the high latency time also means that the audiovisual data is usually displayed on the user's terminal device at different times. The time of the display can vary up to 30 seconds with latency times that are usually between 3 and 40 seconds. As a result, there is no concurrency in the playback of audiovisual media content on the respective user terminals, which can impair the sense of community experience in the live broadcast event. However, the feeling of community experience can certainly intensify media consumption emotionally. In addition, if users are to be able to interact with a provider or with other users on the basis of the media content consumed, for example by placing bets or simply exchanging comments, it is essential that the audiovisual media stream be played as simultaneously as possible. In other words, the lowest possible latency time is required in the delivery of the audiovisual media stream to the individual user terminals and its reproduction on screens of the user terminals.

The personal feeling of a community experience of the live broadcast event could also be intensified by providing additional information or prompts to users from the provider side as interaction offers to the audiovisual media stream. In this way, the respective user is given the opportunity to communicate with others directly or indirectly via the media content he has just experienced, which gives him the feeling of a shared experience of the live event being broadcast. In conventional ways, these possibilities hardly exist, or are impaired by the lack of synchronization.

It is therefore the object of the invention to provide audiovisual media streams together with additional information or prompts as interaction offers in such a way that they can be played back from user terminals as simultaneously and synchronously as possible and with the lowest possible latency.

These objects are achieved through the features of claim 1. Claim 1 refers to a method for data transmission in which an audiovisual media stream of a live event, for example a sports event, is sent by a first provider via the Internet and/or via at least one mobile radio network to a plurality of user terminals, and a data stream generated on the basis of the live event is made available by a second provider for further processing or display via the Internet and/or via at least one mobile radio network. According to the invention, it is proposed for this purpose that the audiovisual media stream and the data stream are fed to a data processing device which generates a sequence of temporally spaced data packets from the data stream and provides each data packet with identification information identifying the respective data packet and a time stamp, wherein the generated data packets are synchronized with the media stream at controllable time intervals using the time stamp and sent over a bidirectional communication link using real-time transfer protocols to a group of user terminals for simultaneous playback synchronized with the audiovisual media stream.

The terms “first provider” and “second provider” are intended to make it clear that in practice the audiovisual media stream and the data stream come from different technical sources, although they could of course be the same company in a legal sense. Similarly, the operator of the method according to the invention could also be the “first provider” and/or “second provider” in the legal sense.

The second provider is a provider who may also be present on site with its own equipment for image and sound production, or may provide data streams generated on the basis of the live event using audiovisual data already recorded for the distribution of sports data by media partners. These data streams do not include audiovisual data, but data such as scores, statistics and other evaluations of the current live event. The data streams are, strongly dependent on the respective live event, such as the respective sport, in terms of their data volume and time structure and are subject to strong fluctuations in terms of data volume and time structure. Therefore, they are not inherently suitable for synchronization with continuously transmitted media streams or for simultaneous display on user devices. In the following, “simultaneity” is understood to mean the momentary occurrence of several events at the same time, i.e. the simultaneous presentation of a certain audiovisual media content with the data of a generated data package on several user terminals. “Synchronization” also means a recurring simultaneity, i.e. a constant sequence of simultaneous presentations of a certain audiovisual media content with the data of a generated data package on several user terminals.

According to the invention, a sequence of data packets spaced apart in time is generated from the data stream by a data preparation device as a first step, wherein the generated data packets are synchronized with the media stream at controllable time intervals. With the help of the operator-side generation of such a sequence of temporally spaced data packets with controllable time intervals, a synchronization with the media stream can be achieved. The generation of the data packets is preferably carried out with an algorithm that recognizes typical events on the basis of the data stream and creates information or prompts tailored to these events as interaction offers. Such algorithms are basically known and are also used for generating the data streams themselves. For example, they are able to automatically recognize typical events from the audio and video material, such as scoring a goal or a penalty kick in soccer. Similar algorithms are used according to the invention to generate the data packets, for example by adding the prompt “Will team X equalize?” or “Will a goal be scored from the penalty kick?” as a ready-to-send data packet in the examples mentioned above. Each data packet is then provided with identification information identifying the data packet and a time stamp in a data header, which conventionally contains the control information for the transmission of the data packet over the Internet. The time stamp enables synchronization with the audiovisual media stream, which has usually already been time stamped by the first provider, usually in the data header blocks of the so-called “frames” with which a media stream is transmitted. At the user terminal, it is then ensured that a data packet and a frame of the media stream with the same time stamp are played back simultaneously at the user terminal. For example, playback can be done using a split screen, in which a first half of the screen displays the content of the audiovisual media stream and a second half of the screen displays the content of the data packet, for example a commentary, additional information, or a prompt for the question “Will team X equalize?”.

According to the invention, the data packets synchronized with the media stream are transmitted to a group of user terminals via a bidirectional communication link using real-time transfer protocols and real-time streaming protocols. The group of user terminals is preferably defined by prior registration of the users with an operator of the method according to the invention. In this process, an interested user logs on to the operator of the method according to the invention by disclosing his connection data and optionally also by disclosing a specific group as a member of which he wishes to participate, for example by means of a web-based application, or by prior installation of a corresponding software application (“app”) on his terminal device. The user concerned then receives the data packets synchronized with the media stream.

An essential aspect of the method according to the invention is the controllability of the time interval between two consecutive data packets. On the one hand, this makes it possible to meet the requirements of different live events, since some live events are characterized by faster changes in the action than others on the other hand, it is also possible to focus on the quality of the bidirectional communication link, which is essentially determined by the maximum possible bit rate of the transmission, the number of frames per second transmitted and the latency times of the transmission. If the quality is poor, i.e. at low bit rates and a low number of transmitted frames per second as well as long latency times, the time interval between two consecutive data packets will be greater than with comparatively high quality. Possible criteria for this will be discussed below.

The transmission is carried out by means of real-time transfer protocols. Real-time protocols are protocols that allow data to be transmitted with negligible latency. In the present case, the latency is negligible in particular if any latency that may be present would be technically measurable but is not perceptible by the user, i.e. if, for example, two images are perceived as being displayed simultaneously although they were actually displayed with a minimal time difference. A real-time transfer protocol is characterized in that no intermediate storage of the data on its way from the sender to the receiver is provided. Conventional HTTP is therefore not a real-time protocol, for example, because it provides for the intermediate storage of data on the user's terminal device before it is played back. An example of a real-time transfer protocol is currently RTP (Real Time Protocol). RTP can be used with UDP and IP as IP/UDP/RTP. Video and audio data are “packed” in RTP data packets, which in turn are packed in UDP (User Datagram Protocol) and IP (Internet Protocol) datagrams. RTP is designed for real-time traffic over the Internet to operate on any type of network protocol by not depending on any information in the lower levels of the computing network model. RTP is usually only implemented over IP/UDP, but could be used as a protocol on any type of packet network, e.g. ATM or ISDN. The practical implementation can be done with the help of WebRTC (Web Real-Time Communication), for example. This is an open standard that defines a collection of communication protocols and programming points (API) that enable real-time communication over computer-to-computer links. For example, web browsers can now not only retrieve data resources from backend servers, but also real-time information from other users' browsers.

According to the invention, the transmission of the media stream with the synchronized data packets is carried out via a bidirectional communication connection, which can be realized for example via so-called WebSockets. This is a bidirectional connection between a web application and a WebSocket server, i.e. a web server that also supports WebSockets. While with a conventional HTTP connection, each action of the server requires a previous request from the user, with the WebSocket protocol a single opening of the connection is sufficient. The server can then actively use this open connection to deliver the media stream and synchronized data packets to the user without waiting for the user to reestablish the connection. From a technical point of view, with WebSocket, the user starts a request for data transmission, wherein, after the initial data for establishing the connection has been transmitted, the underlying TCP connection remains in place and allows asynchronous transmissions in both directions.

The transmission is usual carried out by means of a CDN (Content Delivery Network or Content Distribution Network). A content delivery network is a network of regionally distributed servers connected via the Internet, with which content, usually large media files, are delivered. A CDN provides scalable storage and delivery capacity and is organized in the form of interconnected nodes, wherein the CDN nodes are distributed across many locations and backbones. The task of the CDN is to serve user requests for content as economically as possible. Individual locations are also known as PoP (Point of Presence) and consist of server clusters.

The method according to the invention enables the transmission of audiovisual media streams as well as synchronized data packets with a latency time of leas than 300 ms. This short latency ensures that the transmitted data is reproduced on all user terminals so that it is perceptible to all users at the same time. Within the scope of this simultaneous playback, synchronized playback with data packets generated by the operator also takes place.

The content of the synchronized data packets is basically freely selectable. For example, this can be additional information or comments on the transmitted contents of the media stream. However, it is preferable to suggest that the generated data packets each contain a prompt displayed at the user terminals, and that a user-generated data packet is created from a user input and the identification information of the relevant data packet and sent to the data preparation device via the bidirectional communication link for evaluation or forwarding to other users.

It is further proposed that the data packets synchronized with the media stream by means of the time stamp are transmitted by the data preparation device at different bit rates via the bidirectional communication link. The user terminal has access to the media stream and the data packets synchronized with the media stream at different bit rates, allowing the user terminal to select the appropriate bit rate depending on the performance of the terminal and reception quality to optimize playback quality.

As has already been mentioned, all essential aspect of the method according to the invention is the controllability of the time interval between two consecutive data packets. This is particularly important in order to ensure the quality of the bidirectional communication link between the data preparation device and the user terminals. On the basis of mathematical models and the practical experience of the applicant, it was possible to develop a useful criterion for this purpose, according to which the controllable time interval between two successive data packets of the sequence of data packets spaced apart in time is controlled in such a way that it meets the criterion Δ>(BR/FPS)t_{ed}, wherein BR is the bit rate of the audiovisual media stream transmitted to the group of user terminals in kb/s (kilobits per second), FPS is the number of frames per second of the audiovisual media stream transmitted to the group of user terminals, and t_{ed} is the latency time in seconds of the transmission of the audiovisual media stream transmitted to the group of user terminals between the data preparation device and the user terminals. Good connection quality may be characterized, for example, by a bit rate of 2500 kb/s at 60 FPS and a latency time t_{ed} between the data preparation device and the user terminals of, for example, 100 ms, resulting in a lower limit for the time interval ΔT between two data packets generated by the data preparation device of 4.2 seconds. A poorer connection quality may be characterized, for example, by a bit rate of 500 kb/s at 30 FPS and a latency time t_{ed} between the data preparation device and the user terminals of, for example, 500 ms, so that according to the proposed criterion the time interval ΔT between two data packets generated by the data preparation device should be at least 8.3 seconds. These limits represent technical limits for the time interval ΔT, which must be observed in any case due to the transmission quality of the bidirectional communication link between the data preparation device and the user terminals. Of course, above these technical limits, the time interval ΔT can be chosen at will.

As already mentioned, the generated data packets can, for example, each contain a prompt displayed on the user terminal devices. A user-generated data packet can be created from a user input and the identification information of the relevant data packet. This data packet is sent to the data preparation device via the bidirectional communication link for evaluation or forwarding to other users. The evaluation and possible forwarding of the data is, of course, preferably automated in the data preparation device, since in practical operation a large number of data packages generated by the operator and user-generated data packages can be expected. It would be advantageous to have criteria that check the correct sequence of this process of sending and receiving data packets, i.e. plausibility criteria that make it possible to detect manipulations, for example. A simple criterion has proved to be particularly effective for this purpose, and it is proposed that the evaluation of the user-generated data package should include a check of the criterion

$$\frac{( qet - rt ) ⨯ 100}{\frac{1}{FPS} ⨯ 1000 + ( tBE + tE + tED + tD )} > 60 \%$$

wherein
“qet” is a predetermined maximum time in seconds, measured from the time a particular data packet is sent by the data preparation device to the user terminals, for the preparation of the user input,
“rt” is the actual time in seconds until a user-generated data packet arrives at the data preparation device,
“FPS” is the number of frames per second of the audiovisual media stream transmitted to the group of user terminals,
“t_{BE}” is the latency time in seconds of the transmission between the first provider and the data preparation device,
“t_{E}” is the data processing latency time in seconds at the data preparation device,
“t_{ED}” is the latency time in seconds of the transmission of the audiovisual media stream transmitted to the group of user terminals between the data processing equipment and the user terminals, and
“t_{D}” is the latency time of data processing and display at the user terminal in seconds,
   and if the criterion is not met, the user-generated data packet in question is discarded.

If the ratio described above is below 60%, the user-generated data packet in question is rejected, since technically hardly explainable anomalies exist and manipulations cannot be ruled out.

The invention will be described in more detail in the following on the basis of embodiment examples using the enclosed figures, wherein:

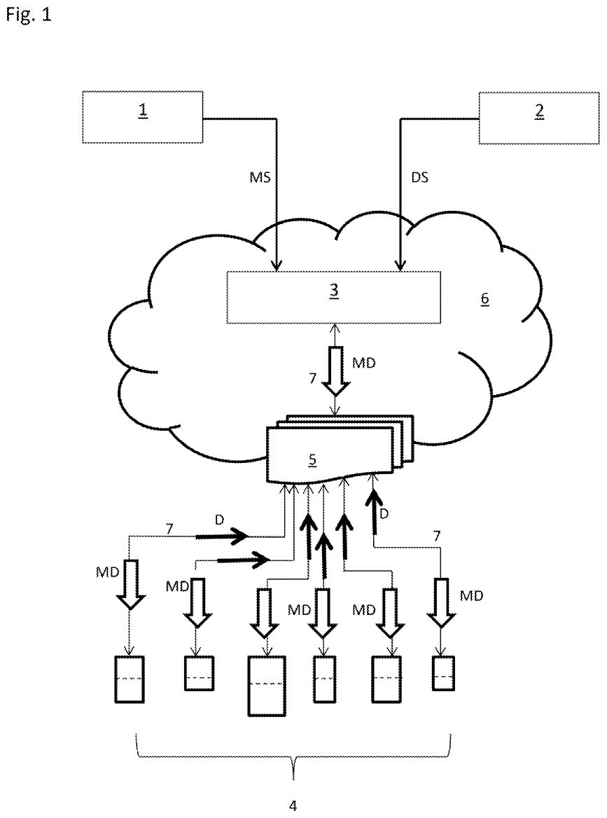

FIG. 1 shows a schematic representation of an embodiment of a method according to the invention, and the

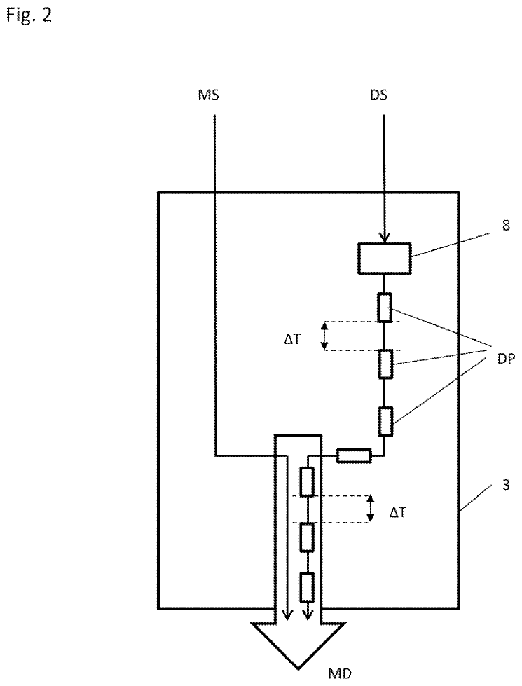

FIG. 2 shows a schematic diagram of an embodiment of the data preparation device.

Firstly, reference is made to FIG. 1, which shows the basic functioning of the method according to the invention. A first provider 1 is located on site of a live event, such as a sports event, with appropriate equipment to obtain images and sound recordings and makes these images and sound recordings available as an audiovisual media stream MS via the Internet 6 and/or via at least one mobile network to a large number of user terminals 4. A second provider 2 generates a data stream DS on the basis of the live event and makes this data stream DS available for further processing or display also via the Internet 6 and/or via at least one mobile phone network. In the traditional way, the data streams DS are intended for professional users and not for the private consumer. In the case of sports events, they contain a wealth of sports data which can be used, for example, to detect any attempts at manipulation. The second provider 2 can either be on site with its own equipment for image and sound acquisition or generate the data stream DS using audiovisual data already recorded. As mentioned above, these data streams DS are highly dependent on the live event, such as the sport in question, in terms of the amount of data and the timing structure, and are subject to wide variations in terms of data size and timing structure.

In the context of the present invention, the method according to the invention makes use of the audiovisual media stream MS and the data stream DS by feeding them to a data preparation device 3 operated by an operator of the method according to the invention. The data preparation device 3 essentially carries out two steps, as explained in FIG. 2. In a first step, a sequence of time-spaced data packets DP is generated from the data stream DS at controllable intervals ΔT. The generation of the data packets DP is preferably carried out with an algorithm 8, which recognizes typical events on the basis of the data stream DS and generates information or prompts tailored to these events as interaction offers. As already mentioned, such algorithms 8 are basically known and are also used for generating the data streams DS itself. For example, they are able to automatically recognize typical events from the audio and video material, such as scoring a goal or a penalty kick in soccer. Similar algorithms 8 are used according to the invention to generate the data packets DP, for example by adding the prompt “Will team X equalize?” or “Will a goal be scored from the penalty kick?” as a ready-to-send data packet DP. The content of the data packets DP is in principle freely selectable. Therefore, it may concern additional information or comments on the transmitted contents of the media stream MS. Each data packet DP is subsequently provided with identification information identifying the respective data packet and a time stamp in a data header, which in a conventional manner contains the control information for the transmission of the data packet DP via the Internet.

In a second step, the generated data packets DP are synchronized with the media stream MS at controllable intervals ΔT. The controllable time interval ΔT between two consecutive data packets DP of the sequence of time-spaced. data packets DP is selected approximately 80 that it meets the criterion

ΔT>(BR/FPS)t_{ed},

wherein BR is the bit rate in kb/s (kilobits per second) of the audiovisual media stream MS transmitted to the group of user terminals 4, FPS is the number of frames per second of the audiovisual media stream MS transmitted to the group of user terminals 4, and t_{ed} is the latency time in seconds of the transmission of the audiovisual media stream MS transmitted to the group of user terminals 4 between the data processing device 3 and the user terminals 4. This criterion provides a lower limit for the selectable time intervals ΔT, which is determined by the connection quality of the transmission between the data processing unit 3 and the user terminals 4. A poorer connection quality generally requires longer intervals ΔT than a relatively good connection quality. Of course, above these technical limits, the time interval ΔT can be chosen at will.

The synchronization is carried out using the time, stamps of the data packets DP and the time stamps of the audiovisual media stream MS, usually already provided by the first provider 1, usually in the data header of the so-called “frames” used to transmit a media stream. The result is an audiovisual media stream MS, which was synchronized with data packets DP with controllable time intervals ΔT and is henceforth and in FIGS. 1 and 2 also referred to as synchronized media data stream MD. It is advantageous if the synchronized media data stream MD is provided and transmitted by the data preparation unit 3 with different hit rates. The synchronized media data stream MD is thus available to user terminal 4 at different bit rates, so that user terminal 4 can select a suitable hit rate depending on the performance of the terminal and reception quality to optimize playback quality.

Reference is now made again to FIG. 1. The synchronized media data stream MD is transmitted via a bidirectional communication link 7 using real-time transfer protocols to a group of user terminals 4. An example of a real-time transfer protocol is currently RTP (Real Tine Protocol). RTP can be used with UDP and IP as IP/UDP/RTP. The practical implementation can be carried out with the help of WebRTC (Web Real-Time Communication), for example. The bidirectional communication link 7 can be implemented, for example, via so-called WebSockets, wherein the transmission of audiovisual data is usually carried out using a content delivery network 5 (CDN or Content Distribution Network). A content delivery network 5 is a network of regionally distributed servers connected via the Internet, with which content, usually large media files, are delivered. Individual locations are also known as PoP (Point of Presence) and consist of server clusters.

The group of user terminals 4 is preferably defined by prior registration of the users with the operator of the method according to the invention. In this process, an interested user logs on to the operator of the method according to the invention by disclosing his connection data and optionally also by disclosing a specific group as a member of which he wishes to participate, for example by means of a web-based application, or by prior installation of a corresponding software application (“app”) on his terminal device. For example, using a WebSocket protocol, the user initiates a request to transfer data, wherein after the initial data for establishing the connection has been transferred, the underlying TCP connection remains in place and allows asynchronous transfers in both directions. The respective user then receives the data packets DP synchronized with the media stream MS as a synchronized media data stream MD. Since the synchronized media data stream MD is available to user terminal 4 at different bit rates, user terminal 4 can subsequently select a suitable bit rate to optimize playback quality depending on the performance of the terminal and reception quality.

At user terminal 4 it is then ensured that during the reception of the synchronized media data stream MD, a data packet. DP and a frame of the media stream MS with the same time stamp are displayed simultaneously at user terminal 4. For example, the playback can be done by using a split screen, as indicated by the dotted lines in FIG. 1, by displaying in a first half of the screen the content of the audiovisual media stream MS, and in a second half of the screen the content of the data packet DP, for example a comment, additional information, or a prompt for the question “Will team X equalize?”.

Using a traditional input device on the user terminal 4, the user can make an input at the prompt. From the user input and the identification information of the relevant data packet DP, a user-generated data packet D is subsequently created and sent via the bidirectional communication link 7 to the data preparation unit 3 for evaluation or forwarding to other users, wherein the aforementioned content delivery network 5 can be used. The data preparation device 3 can use the relevant input, for example for competitions, or compere it with the input of other users.

The evaluation and possible forwarding of the data in data preparation device 3 is, of course, preferably automated, since in practical operation a large number of data packets DP generated by the operator and data packets D generated by the user are to be expected. It would be advantageous to have criteria that check the correct sequence of this process of sending and receiving data packets DP, i.e. plausibility criteria that make it possible to detect manipulations, for example. A simple criterion has proved to be particularly effective for this purpose, and it is therefore proposed that the evaluation of the user-generated data package D should include a review of the criterion

$$\frac{( qet - rt ) ⨯ 100}{\frac{1}{FPS} ⨯ 1000 + ( tBE {+}_{> 60 \%} D + tD )}$$

wherein
“qet” is a predetermined maximum time in seconds, measured from the time a particular data packet DP is sent by the data preparation device 3 to the user terminals 4, for the preparation of the user input,
“rt” is the actual time taken for a user-generated data packet D to arrive at the data preparation device 3 in seconds,
“FPS” is the number of frames per second of the audiovisual media stream MS transmitted to the group of user terminals 4,
“t_{BE}” is the latency time in seconds of the transmission between the first provider and the data preparation device 3,
“t_{E}” is the data processing latency time in seconds for the data preparation device 3,
“t_{ED}” is the latency time in seconds of the transmission of the audiovisual media stream MS transmitted to the group of user terminals 4 between the data processing equipment 3 and the user terminals 4, and
“t_{D}” is the latency time of data processing and display at the user terminal 4 in seconds,
   and if the criterion is not met, the user-generated data packet D in question is discarded.

If the ratio described above is below 60%, the user-generated data packet D in question is thus rejected, since technically hardly explainable anomalies exist and manipulations cannot be ruled out.

If no anomalies can be detected and manipulation can be ruled out, a notification of any kind is usually sent from the data preparation device 3 to the user concerned in response to the input of a user, in order to promote the community experience of the live event. This can be a notification, for example, about which or how many users in the same group have correctly answered questions that have been asked so far and include a corresponding ranking.

The method according to the invention enables the transmission of audiovisual media streams MS as well as synchronized data packets DP with a latency time of less than 300 ms. This short latency ensures that the transmitted data is reproduced on all user terminals 4 in a way that is perceptible to all users at the same time. During this simultaneous playback, synchronized playback with the data packets DP generated by the operator also takes place. This also allows users to interact based on the live event they have just experienced, both with the operator of the method according to the invention and with other users, thus intensifying the community experience of the live event being broadcast.

1. A method for data transmission, in which an audiovisual media stream of a live event, for example a sports event, is sent by a first provider via the Internet and/or via at least one mobile radio network to a plurality of user terminals, and a data stream generated on the basis of the live event is made available by a second provider for further processing or display via the Internet and/or via at least one mobile radio network, wherein the audiovisual media stream and the data stream are fed to a data preparation device, which generates from the data stream a sequence of temporally spaced data packets and provides each data packet with identification information identifying the respective data packet and a time stamp, wherein the generated data packets are synchronized with the media stream at controllable time intervals using the time stamp and sent via a bidirectional communication link using real-time transfer protocols to a group of user terminals for simultaneous playback synchronized with the audiovisual media stream.

2. The method according to claim 1, wherein the real-time transfer protocol is RTP (Real Time Protocol).

3. The method according to claim 1, wherein the generated data packets each contain an input prompt displayed on the user terminals, and a user-generated data packet is created from a user input and the identification information of the relevant data packet and is sent to the data preparation device via the bidirectional communication link for evaluation or forwarding to other users.

4. The method according to claim 1, wherein the data packets synchronized with the media stream with the aid of the time stamp are transmitted by the data preparation device at different bit rates via the bidirectional communication link.

5. The method according to claim 1, wherein the controllable time interval between two successive data packets of the sequence of time-spaced data packets is controlled in such a way that it satisfies the criterion ΔT>(BR/FPS)t_{ED}, wherein BR is the bit rate in kb/s of the audiovisual media stream transmitted to the group of user terminals, FPS is the number of frames per second of the audiovisual media stream transmitted to the group of user terminals , and t_{ED} is the latency time in seconds of the transmission of the audiovisual media stream transmitted to the group of user terminals between the data preparation device and the user terminals.

6. The method according to claim 3, wherein the evaluation of the user-generated data packet involves a check of the criterion
$$\frac{( qet - rt ) ⨯ 100}{\frac{1}{FPS} ⨯ 1000 + ( tBE + tE + tED + tD )} > 60 \% ,$$
wherein
“qet” is a predetermined maximum time in seconds, measured from the time a particular data packet is sent by the data preparation device to the user terminals for the preparation of the user input,
“rt” is the actual time in seconds until a user-generated data packet arrives at the data preparation device,
“FPS” is the number of frames per second of the audiovisual media stream transmitted to the group of user terminals,
“t_{BE}” is the latency time in seconds of the transmission between the first provider and the data preparation device,
“t_{E}” is the latency time in seconds of the data processing at the data preparation device,
“t_{ED}” is the latency time in seconds of the transmission of the audiovisual media stream transmitted to the group of user terminals between the data preparation device and the user terminals, and
“t_{D}” is the latency time in seconds of data processing and display at the user terminal,
and if the criterion is not met, the user-generated data packet in question is discarded.
